(19) United States
(12) Patent Application Publication
(10) Pub. No.: US 2018/0112519 A1
(43) Pub. Date: Apr. 26, 2018

(54) APPLICATION OF DEPTH DERIVATIVE OF DTS MEASUREMENTS IN IDENTIFYING INITIATION POINTS NEAR WELLBORES CREATED BY HYDRAULIC FRACTURING

(71) Applicant: Halliburton Energy Services, Inc., Houston, TX (US)

(72) Inventors: Hongyan Duan, Houston, TX (US); Eric Holley, Tomball, TX (US); Mikko Jaaskelainen, Katy, TX (US)

(21) Appl. No.: 15/567,900

(22) PCT Filed: Jun. 15, 2015
(86) PCT No.: PCT/US2015/035889

§ 371 Date: Oct. 19, 2017

(51) Int. Cl. E21B 47/06; E21B 43/26; E21B 43/16; G01K 11/32

(52) U.S. Cl. CPC E21B 47/065; E21B 43/26; G01K 2011/324; G01K 11/32; E21B 43/162

(57) ABSTRACT

A method for using the depth derivative of distributed temperature sensing data to identify initiation points near wellbores created by hydraulic fracturing comprises providing a fiber optic based distributed temperature sensing measurement system through a production region; gathering the temperatures through the production region as a function of the depth in the sub-surface well and as a function of the elapsed time; calculating from the gathered data the depth derivative of the temperature changes as a function of depth in the subsurface well and of the elapsed time; and displaying the depth derivative data for analysis of initiation points near wellbores created by hydraulic fracturing.

### BACKGROUND

This disclosure relates generally to temperature sensing, and more particularly, to the use of new methodologies for interpreting distributed temperature sensing information.

Fiber optic Distributed Temperature Sensing (DTS) systems were developed in the 1980s to replace thermocouple and thermistor based temperature measurement systems. DTS technology is often based on Optical Time-Domain Reflectometry (OTDR) and utilizes techniques originally derived from telecommunications cable testing. Today DTS provides a cost-effective way of obtaining hundreds, or even thousands, of highly accurate, high-resolution temperature measurements, DTS systems today find widespread acceptance in industries such as oil and gas, electrical power, and process control.

DTS technology has been applied in numerous applications in oil and gas exploration, for example fluid injection including hydraulic fracturing, production, and cementing among others. The collected data demonstrates the temperature profiles as a function of depth and of time during a downhole sequence. The quality of the data is critical for interpreting various fluid movements.

The underlying principle involved in DTS-based measurements is the detection of spontaneous Raman back-scattering. A DTS system launches a primary laser pulse that gives rise to two back-scattered spectral components. A Stokes component that has a lower frequency and higher wavelength content than the launched laser pulse, and an anti-Stokes component that has a higher frequency and lower wavelength than the launched laser pulse. The anti-Stokes signal is usually an order of magnitude weaker than the Stokes signal (at room temperature) and it is temperature sensitive, whereas the Stokes signal is almost entirely temperature independent. Thus, the ratio of these two signals can be used to determine the temperature of the optical fiber at a particular point. The time of flight between the launch of the primary laser pulse and the detection of the back-scattered signal may be used to calculate the spatial location of the scattering event within the fiber.

In DTS technologies, one of the most important tools in allocating fractures or injection initiation points created by hydraulic injection is to identify a depth where the temperature increases slower than its adjacent zones after the injection is shut-in. The theory is that the injection fluid used by hydraulic fracturing is much colder than the original formation temperature (or geothermal temperature). When a large volume of injection fluid entered the formation rock through fractures, it cools down the formation and wellbore at this depth. After injection is shut-in, wellbore and its near formation rock start being warmed back assuming all fluid flow has stopped in the well. The more cool fluid been injected at this depth, the slower the temperature recovers. At those depths where less fluid has been injected, temperature recovers faster to geothermal. By comparing temperature distribution at different depths after 48 hours or longer of shut-in, one can identify where the large volume of injection fluid entered. This ‘Thermal Recovery’ technology offers an indirect method to identify where the fractures are created in cemented or uncemented completions. This method can be applied to vertical, horizontal, or deviated wellbores. Because the temperature profile along depth is an overall consequence of a fracture distribution and flow transportation in heterogeneous media. While DTS has significantly improved diagnosis of these phenomena it has been limited in what it normally shows.

Fracture initiation analysis includes two processes, identifying the depth where the fracture was initiated near wellbore and deciding which of the initial depths acquired the most volume of the injection. The second conclusion is highly dependent on the first step. The traditional approach accomplishes the processes by observing temperature traces selected directly from DTS data set. By finding noticeable local minimum value along the temperature traces, one can conclude the depth of the fracture initiations and the depth of the largest fluid volume entry into formation.

Because conclusions are made on temperature traces that were selected from a few time steps, large error often occurs if the DTS measurement is unstable during the data collection time. An unstable DTS measurement can be caused by many reasons, from laser device stability, reference coil temperature stability to data integration design. There is a need for better tools to exploit the whole set of data collected from over time to avoid misleading and inaccurate results.

Two methods are widely applied in the industry to investigate these phenomena. DTS single trace analysis and DTS time-depth 2D image analysis. The first one is usually operated by including a limited amount of DTS curves in Depth-Temperature plot to find those noticeable local minimum temperatures on each single trace. The second method is to the DTS data in Time-Depth 2D plot. There is a need for better tools to address these phenomena.

The quest for deeper insights into the data by an alternate approach for increasing the understanding of what is happening has led to the development of this tool.

### BRIEF DESCRIPTION OF THE DRAWINGS

FIG. 1 illustrates a plug-perforation completion well diagram that illustrates the origin of the first example set of DTS data.

FIG. 2 illustrates the first example DTS data acquired from the well of FIG. 1, plotted in time and depth scale.

FIG. 3 illustrates two temperature traces that are collected from same DTS data set as FIG. 2, plotted in depth scale. Each trace illustrates the temperature distribution along wellbore depths at a single time.

FIG. 4 illustrates the depth derivative of the same set of DTS data as FIG. 2, plotted in the same depth and time scales.

FIG. 5 illustrates a second plug-perforation completion well diagram that illustrates the origin of the second example set of DTS data.

FIG. 6 illustrates a second example DTS data acquired from the well of FIG. 5, plotted in time and depth scale.

FIG. 7 illustrates three temperature traces that selected from same DTS data as FIG. 6, plotted in the depth scale. Each trace illustrates the temperature distribution along wellbore depths at a single time.

FIG. 8 illustrates the depth derivative of the same set of DTS data as FIG. 6, plotted in same depth and time scales.

FIG. 9 illustrates a temperature trace selected from same DTS data set as FIG. 6 based on the guideline constructed by depth derivative plot FIG. 8.

FIG. 10 illustrates the data matrices representing the DTS data for representing the depth derivative display.

FIG. 11 illustrates a work-flow for generating the data analysis for the identification.

### DETAILED DESCRIPTION

In the following detailed description, reference is made to accompanying drawings that illustrate embodiments of the present disclosure. These embodiments are described in sufficient detail to enable a person of ordinary skill in the art to practice the disclosure without undue experimentation. It should be understood, however, that the embodiments and examples described herein are given by way of illustration only, and not by way of limitation. Various substitutions, modifications, additions, and rearrangements may be made without departing from the spirit of the present disclosure. Therefore, the description that follows is not to be taken in a limited sense, and the scope of the present disclosure will be defined only by the final claims.

Injection fluid used by hydraulic fracturing enters formation rock and cools all objects, including rock, wellbore and installed fiber sensor. After injection is shut-in and fluid movement stops, all materials start to warm back toward formation geothermal temperature. The more fluid injected, the slower the temperature recovers at any depth. In the traditional approach, fracture initiations can be identified and classified by a thermal recovery methodology following two steps/processes. The first step is to identify the depth where the fracture was initiated near wellbore. It can be accomplished by finding local minimum temperatures along the injection section (fracturing stage) of the wellbore. They are often found at the depths where perforations were opened. For open hole completion, it can be anywhere between the packers that boundary the injection section. The second step is to decide which of the initiated depths acquired the largest volume of the injection. The conclusion is highly dependent on the first step and is addressed by finding the lowest absolute temperature among all local minimums found from the first step.

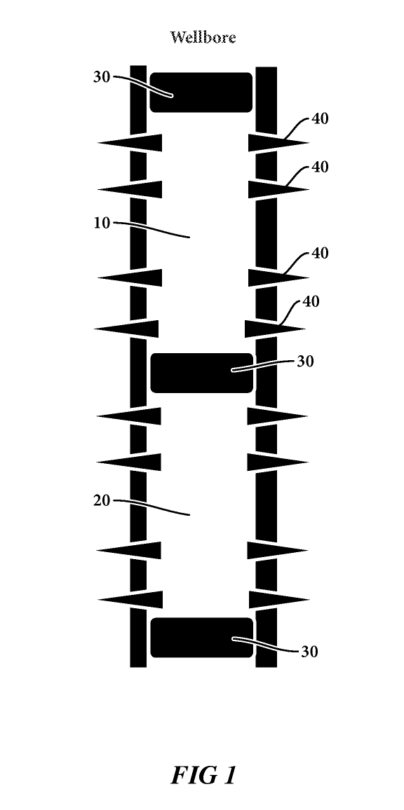

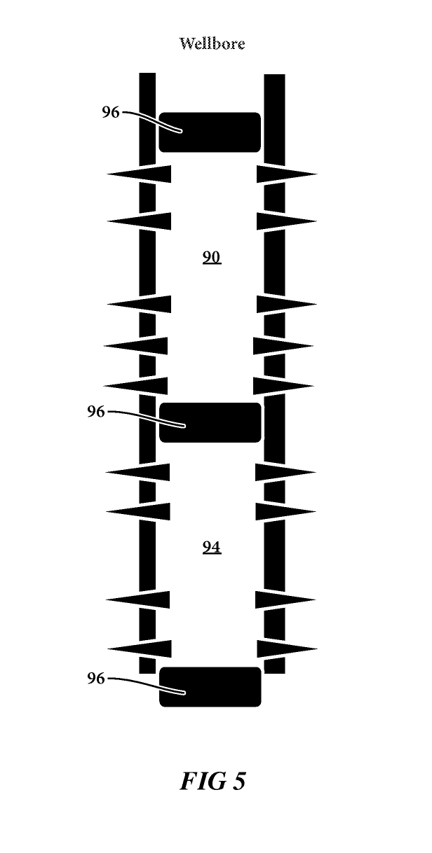

FIGS. 1-4 illustrate this methodology applied on the first set of DTS data. FIGS. 5-9 illustrate this methodology applied on the second set of DTS data. Two set of DTS data are collected from two different wells. They both have plug and perforation completion and hydraulic fracturing is conducted on each well at different times. Two injection sections (fracturing stages) were selected from each well and presented in the images.

The first set of DTS data (FIGS. 1-4) is of good quality, and conclusions on fracture initiation points can be obtained with fairly high certainty. But the new approach presented here is able to discover more details of the fracture initiation points and solve the conflicts between two temperature traces collected from same set of data. The second set of DTS (FIGS. 5-9) is in of lower quality. Fracture allocation can be concluded with low certainty by the traditional trace analysis. It will be more obvious in this case that the use of depth derivative methodology can increase the certainty of the result.

Distributed Acoustic Sensing (DAS) systems may also be used to identify locations where fracturing fluid enters the formation rock. Acoustic intensity changes and/or velocity changes and/or changes in frequency content maybe used to confirm and validate fracture initiation points and can be used together with DTS data to enhance the data interpretation.

In the first example, FIG. 1 describes a plug-perforation completion. Optical fiber is installed outside casing along the wellbore. The graph includes two independent injection sections (fracturing stages), 10 and 20, separated by three plugs 30. The upper stage 10 and lower stage 20 are fractured independently. Perforations clusters 40 are indicated in both stages.

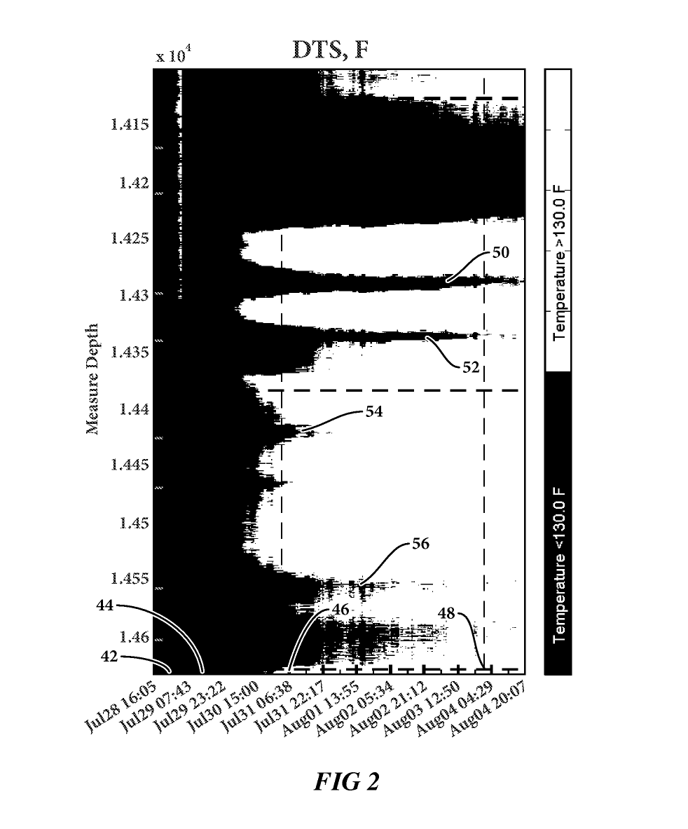

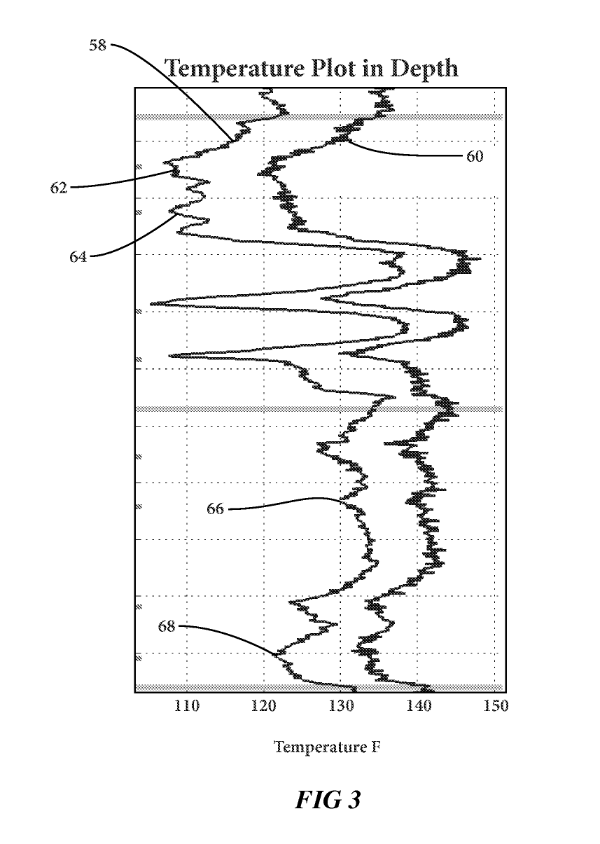

FIG. 2 presents a set of DTS data acquired by optical fiber on these two stages during a hydraulic fracturing and 5 days after shut-in. The shut-in times of upper stage 10 and lower stage 20 are shown as 42 and 44 respectively. The times 46 and 48 will be discussed later in reference to FIG. 3. The vertical axis of the figure is depth in feet. The horizontal axis is time, marked by date and time. The figure shows temperature acquired by optical fiber sensing with respect to depth and time. The black represents cooler temperatures (lower than 130F). The white represents temperatures higher than 130F. At various depths 50, 52, 54, 56 for example lower temperatures last longer than their adjacent depths after shut-in time, indicating that fractures are initiated at these depths.

FIG. 3 illustrates two temperature traces. Trace 58 describes the temperature distribution along depths at the time 42, 2 days after stage 10 shut-in. Trace 60 describes the temperature distribution along depths at time 44, 6 days after stage 1 was shut-in. Trace 60 is warmer than trace 58 because the formation has further heated the wellbore and the fiber from time 46 to time 48. From both traces, the same cooling features can be seen at the same depths as in FIG. 2. At the various depths such as 50, 52, 54, 56 (FIG. 2) a set of local minimums can be seen in each trace. These depths indicate where the fractures have been created and injection fluid entered the formation. In respect to certainty of the conclusion, depths 50 and 52 can be concluded as two fracture initiation points with high certainty, because the same features are found not only on both traces but also on the same depths in FIG. 2. Other depths such as 62, 64, 68 are in low certainty. At depth 64, for example, two local minimums are observed at 64 on one trace, while the other trace shows an inconsistent feature at this depth due to a higher noise. Similar inconsistency between two traces can also be found at depth 68, where one local minimum seems dominated on one trace, while the other shows more than one at same depth.

An alternate method is needed to reach higher certainty of conclusions.

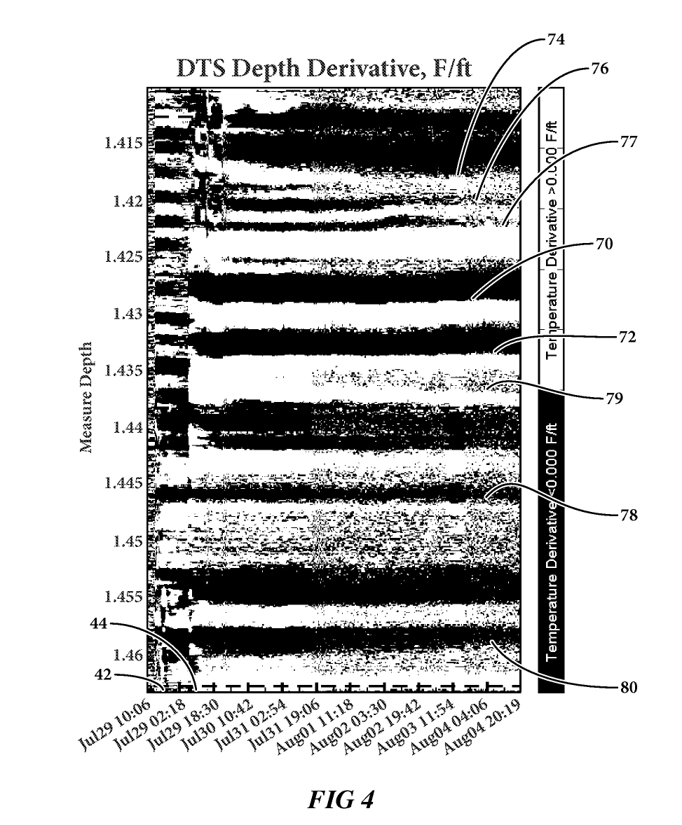

The new approach presented herein, called Depth Derivative, is plotted in FIG. 4. This figure is based on the same DTS data as shown in FIGS. 2 and 3. The algorithm of acquiring depth derivative plot is described in a later section of this disclosure. It is a matrix with same size as the DTS data, plotted in same depth and time scale as FIG. 2. Value at each time and depth coordinates represents a temperature change along its adjacent depth. Changes from low temperature to high temperature (positive change) are represented in white. Changes from high temperature to low temperature (negative change) are represented in black. Finding the boundaries between these two colors lead us to a more accurate representation of where a local minimum temperature exists. And because the boundaries are found persistent through all warm back time, it gives a much higher certainty comparing with the conclusion obtained from analysis of multiple traces.

Referring now back to FIGS. 2 and 3. The fracture initiations concluded by traditional approach at 50 and 52 can also be identified at distinct depth derivatives 70 and 72 in FIG. 4 by the new approach. At other locations, previously discussed at depths 62, 64, and 68 where the conclusions were not certain a clearer understanding emerges in FIG. 4 by observation of the boundaries at 74,76, 77 and 80. They all are more persistent along the time scale although boundary 76 shows deterioration across the time scale. This helps explains why trace 58 in FIG. 3 selected from an earlier time shows four clear local minimums near depth 62 and 64, while trace 60 selected from a later time is much less definitive. By examining details of the fracture initiations from derivative plot (FIG. 4) and comparing the conclusion with trace plot (FIG. 3), it appears that three fractures were initiated at depths 74, 76 and 77. Injected fluid entered into the formation at these three depths causes a delayed warm back of the wellbore. At depth 80, only one fracture initiation point can be concluded. Derivative plot FIG. 4 is able to observe one consistent boundary although in traditional DTS plot, more than one local minimum are shown at depth 68 of FIG. 3. The depth derivative approach is able to identify a true physical event among all other signal noises by observing their consistency in time.

Another insight is gleaned from the indication at depth 79 (FIG. 4) that indicates a fracture initiation is appearing at later time of the warm back. A temperature minimum is not as obvious at this depth in FIG. 3. Depth derivative plot FIG. 4 however shows such a local minimum and consistent over the later 2 days of the warm back. A fracture initiation can be confirmed at the depth 79 and its containing fluid did not take thermal effect until its adjacent depths are warmed back to a higher temperature.

The second DTS data set (FIGS. 5-9) illustrates another example that depth derivative can confirm a conclusion of fracture initiation when traditional DTS trace analysis fail due to the artifacts of data. FIG. 5 illustrates the second well diagram. It is also plug-perforation cemented completion. Two fracturing stages 90, 94 are presented and separated by plugs 96. Stage 90 has 5 perforation clusters and stage 94 has 4 clusters. Fracturing fluid was injected though these clusters into the formation.

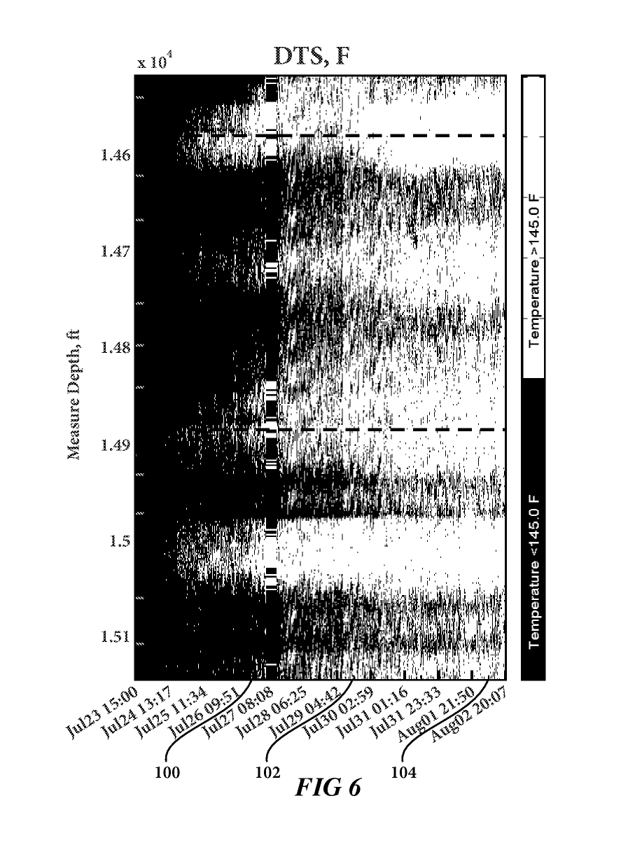

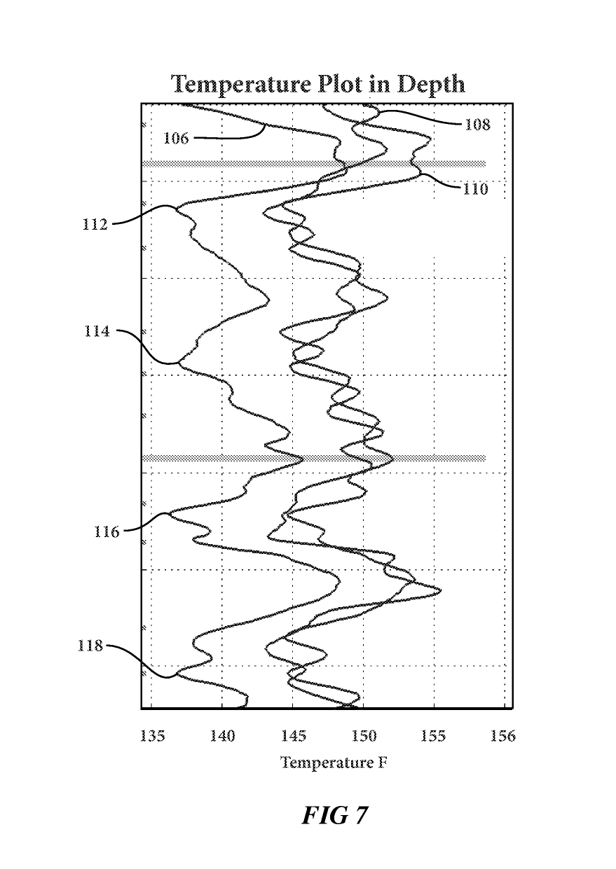

FIG. 6 illustrates DTS data plotted in depth and time scales. Black color represents a temperature lower than 145F and white color represents a temperature high than 145F. As first step of the traditional trace analysis, three temperature traces are selected at time steps 100, 102 and 104, after the injection of both stages was shut-in. The traces corresponding to the three time steps are plotted in FIGS. 7 as 106, 108 and 110.

In FIG. 7, looking at four different depths 112, 114, 116, 118 trace 106 shows two local minimums at depth 112, three minimums at depth 114, two local minimums at depth 116 and two local minimums at depth 118. The corresponding DTS plot in FIG. 6 appears to show four broad cooler bands, some of which could be multiple. Traces 108 and 110 (FIG. 7) however show almost the opposite phenomena at those same depths. The depth at one trace shows a local minimum but shows a local maximum at the other trace. This indicates that artifacts of the data has been involved at many time steps, without differentiating good DTS traces from artifact traces, traditional trace analysis is not able to draw any conclusion.

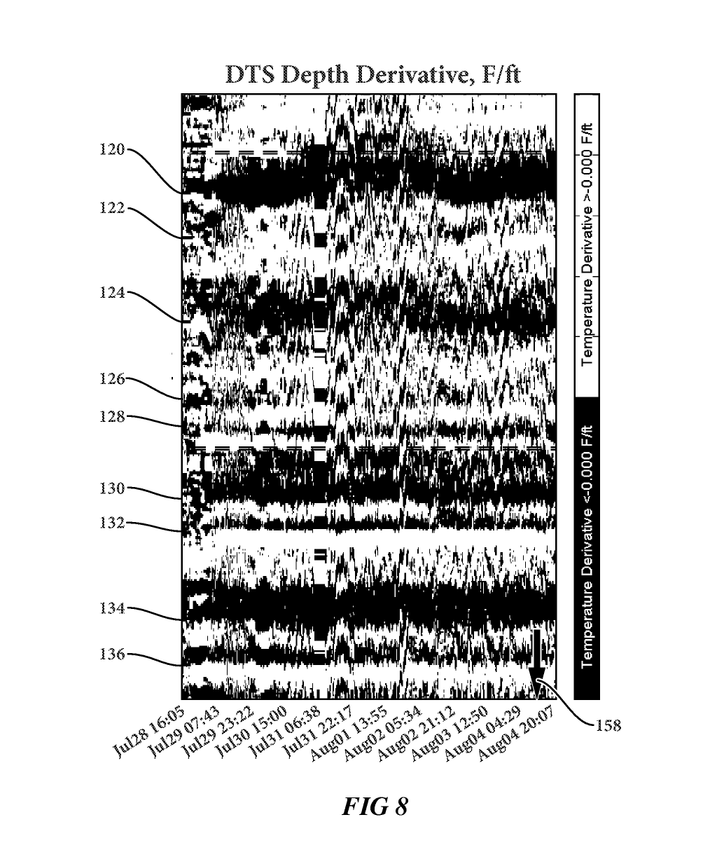

FIG. 8 illustrates the depth derivative of the second DTS data, plotted in the same depth and time scales as FIG. 6. The new approach is designed to identify those persistent boundaries that can be observed through all warm back time, shown as 120-136. Data artifacts at this condition create many disturbances among the persistency of the boundaries. But unlike a few DTS traces, a derivative plot is able to capture a local minimum as a visible boundary only if it is created by an actually temperature variation along depth. Disturbances created by data artifacts are not able to alter these boundaries. For example at depth 122 and 126, signal-to-noise ratio is lower than other depths. Although artifacts and noise cover signals at these two depths in the DTS traces, persistency of the boundaries caused by a true temperature change can be observed through all of the warm back time in the DTS depth derivative.

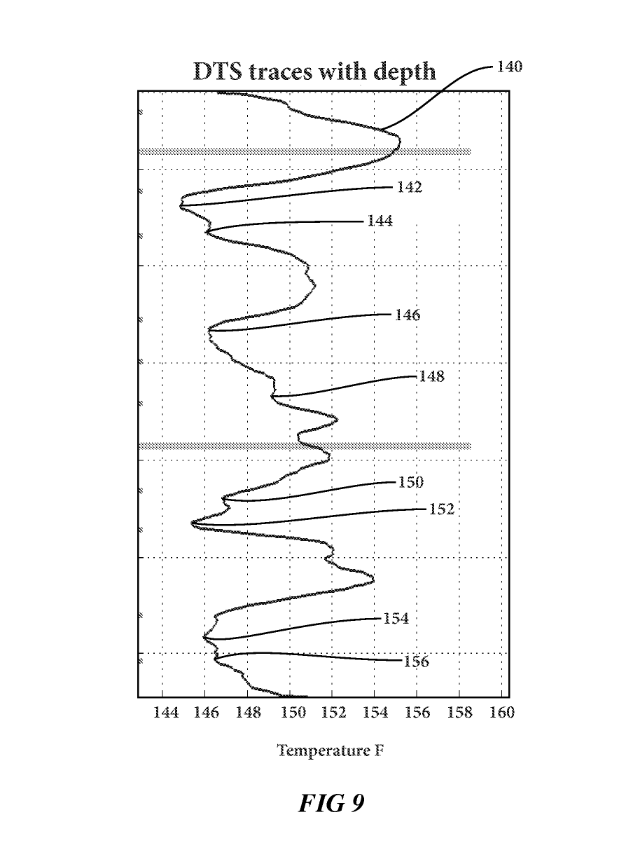

Boundaries identified from the depth derivative, 120 to 136 offers a guideline to select such a DTS trace as 140 in FIG. 9, from which local minimums are found at the same depths, shown as 142 to 156. FIG. 9 illustrates a DTS trace selected from time stamp 158 (FIG. 8) based on this guideline. A trial and error process is required to obtain the trace 140. Unlike the traces randomly selected by traditional approach, the one acquired with the new guideline is able to conclude with much higher certainty. If more traces at different time stamp need to be selected. The same guideline has to be applied to prevent a misleading artifact trace is included.

The conclusions about fractures initiated in presented two stages can be confirmed with high certainty despite the data quality. Five fractures were initiated at top stage and four fractures at bottom stage. This result is consistent with number of the perforation clusters in each stage.

### Generation of Derivative DTS Data

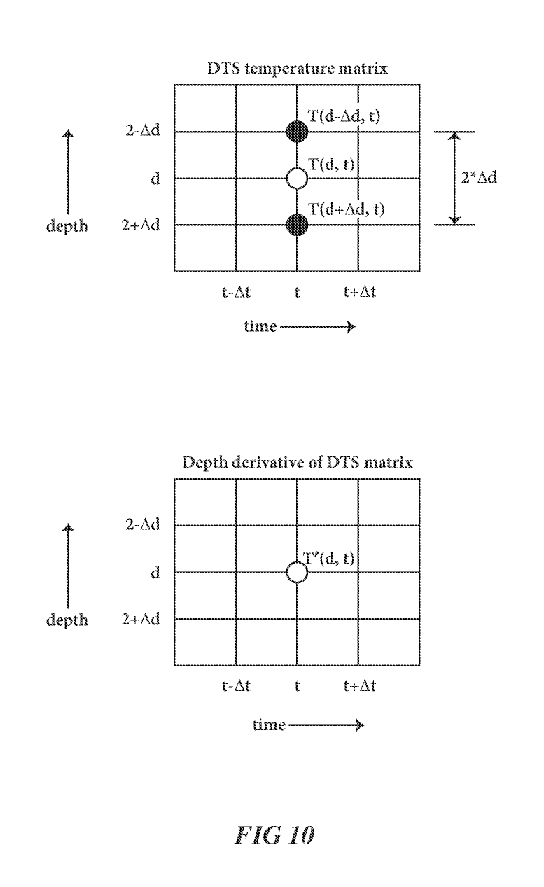

The disclosure herein anticipates any mathematically correct manner of generating the derivative data. The example embodiment for calculating the depth derivative is explained as follows, and is illustrated in FIG. 10.

Derivative data from DTS data can be generated by feeding the numerical data of temperature as a function of depth and time into a matrix and then computationally moving through all of the matrix data points to calculate derivative values for each matrix element. This can be done as either depth derivatives or as time derivatives. These derivative values can then be presented as a matrix of numbers, or, more usefully can be presented as color images in which the various colors represent different values of the derivatives. As discussed earlier, they are presented herein as black/white images that show important features that are not evident in the presentation of the conventional DTS data alone.

Depth derivative of DTS:

In this example the computation language MatLab is used to compute regular DTS data into depth derivative of DTS. And the result can then be plotted by MatLab in depth- time scale.

For DTS measurement, Temperature is function of depth and time:

T=T (depth, time) (1)

Data is loaded into Matab and stored as a DTS temperature matrix. It can be plotted by MatLab or similar programs as in FIG. 3.

The depth derivative of DTS, is then computed as:

T̂′(d,t)=(T(d+Δd,t)−T(d+Δd,t))/(2*Δd) (2)

The depth derivative at any depth and time is calculated by subtracting the temperature at its previous depth channel from the one at its next depth channel and the result is divided by the distance between these two depths. This results in a depth derivative of the DTS temperature matrix. The resulting matrix can be plotted in the same time and depth scale and shown as FIG. 10, wherein each point is a derivative data point to be displayed.

Both the DTS temperature matrix and DTS derivative matrix can be plotted as a depth-time 2D color map by MatLab function pcolor(d,t,T) or pcolor(d,t,T′). Input parameters d and t are depth and time vectors. Input T and T′ are both 2D matrices with the number of rows the same as vector d and the number of columns the same as vector t.

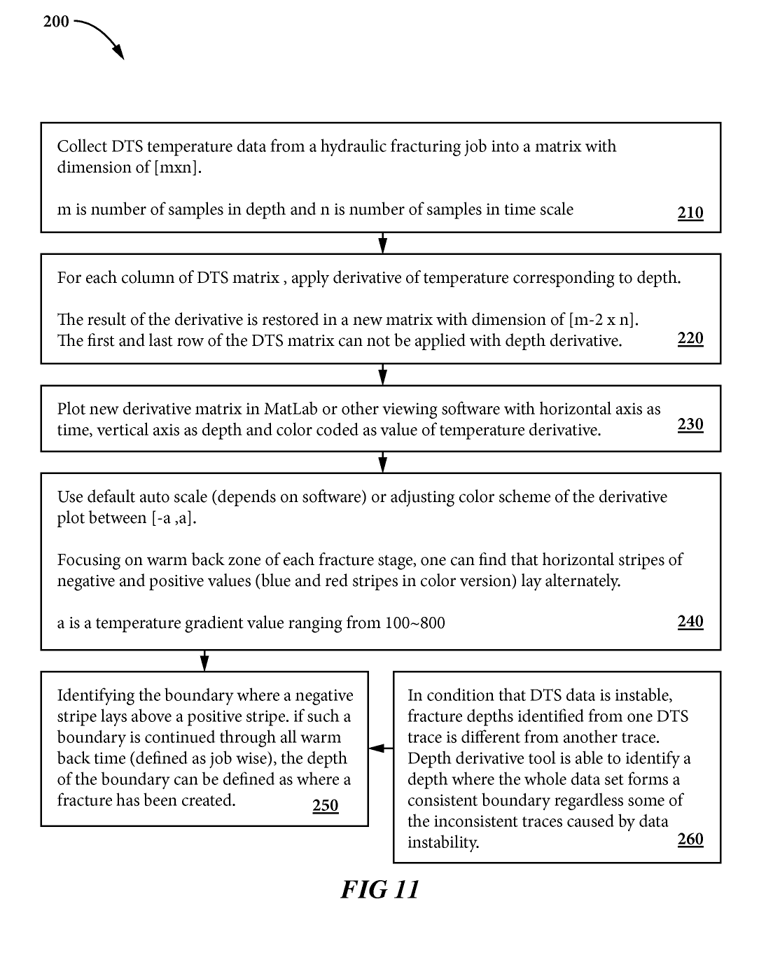

The method can be described alternately with the process 200 as in FIG. 11. In the first step 210 a DTS system is used to collect temperature data from a hydraulic fracturing job into a matrix of dimensions [m×n], where m is the number of samples taken in the depth scale and n is the number of samples taken in time scale. In the step 220 for each column of the DTS matrix, the derivative of temperature corresponding to depth is calculated. The result of this derivative is stored in a new matrix with dimension [m−2×n]. The first and last row of the DTS matrix cannot be applied with the depth derivative. The developing depth derivative matrix is shown in FIG. 10. In the step 230 any viewing software such as MatLab can be used to plot the derivative matrix with time as the horizontal axis and depth as the vertical axis. If color display is operable the color can be coded as a value of temperature derivative. The user can then adjust (step 240) the color scheme of the derivative plot while focusing on the warm back stage of each fracture stage until one or more persistent horizontal stripes of negative and positive values are evident. In a color display this would be blue and red stripes. In a black and white display the derivative plots appear as in FIGS. 4 and 8. The user can easily identify the boundaries where a negative stripe (black) lays above a positive stripe (white). If such a boundary is continued through all warm back time, the depth of each boundary can be defined as where a fracture has been created (step 250).

It should be noted (step 260) that when the DTS data is of poorer quality the temperature traces (as in FIG. 7) make it quite difficult (or impossible) to identify the boundaries of fractures. But the depth derivative data (FIG. 8) forms boundaries across the entire time region despite the inconsistent traces.

By default, MatLab uses a Blue-Red color scheme represent the value of the temperature or value of the derivative. Again, as explained before, because color cannot be used in patent applications these are presented as Black/White scale images which still show the new possibilities of data presentation possible by the use of displayed color data. In the DTS plots, shown in FIGS. 2 and 6, black represents a low temperature while white represents a high temperature.

In DTS the depth derivative as shown as FIGS. 6 and 8, black represents a temperature decrease along the depth. White represents a temperature increase along the depth. Again because color cannot be used in patent applications these are presented as black/white scale images which still show the new possibilities of data presentation possible by the use of displayed color data.

The resulting depth derivative temperature data as a function of depth and time can be presented in a number of ways. In one example the actual numerical values can be stored for later retrieval and then either displayed on a monitor or printed for study. In another example the resulting depth derivative of temperature can be displayed as different colors on a color display for better understanding and interpretation. In yet another example that same data can be displayed in black/white scale as shown in FIG. 2. Although not shown, the same data can be shown in gray scale.

Although certain embodiments and their advantages have been described herein in detail, it should be understood that various changes, substitutions and alterations could be made without departing from the coverage as defined by the appended claims. Moreover, the potential applications of the disclosed techniques is not intended to be limited to the particular embodiments of the processes, machines, manufactures, means, methods and steps described herein. As a person of ordinary skill in the art will readily appreciate from this disclosure, other processes, machines, manufactures, means, methods, or steps, presently existing or later to be developed that perform substantially the same function or achieve substantially the same result as the corresponding embodiments described herein may be utilized. Accordingly, the appended claims are intended to include within their scope such processes, machines, manufactures, means, methods or steps.

1. A method for using the depth derivative of distributed temperature sensing data to identify initiation points near wellbores created by hydraulic fracturing comprising:
a. providing a fiber optic based distributed temperature sensing measurement system through a production region;
b. gathering the temperatures through the production region as a function of the depth in the subsurface well and as a function of the elapsed time;
c. calculating from the gathered data the depth derivative of the temperature changes as a function of depth in the subsurface well and of the elapsed time;
d. displaying the depth derivative data for analysis of initiation points near wellbores created by hydraulic fracturing.

2. The method for using the depth derivative of distributed temperature sensing data to identify initiation points near wellbores created by hydraulic fracturing of claim 1 wherein the numerical values of the depth derivative data are recorded and printed or displayed.

3. The method for using the depth derivative of distributed temperature sensing data to identify initiation points near wellbores created by hydraulic fracturing of claim 1 wherein the depth derivative data is displayed in colors as a function of depth and time on a display monitor.

4. The method using the depth derivative of distributed temperature sensing data to identify initiation points near wellbores created by hydraulic fracturing of claim 1 wherein the depth derivative data is displayed in black/white scale as a function of depth and time on a display monitor.

5. The method using the depth derivative of distributed temperature sensing data to identify initiation points near wellbores created by hydraulic fracturing of claim 1 wherein the depth derivative data is displayed in grey scale as a function of depth and time on a display monitor.

6. The method for using the depth derivative of distributed temperature sensing data to identify initiation points near wellbores created by hydraulic fracturing of claim 1 further comprising:
a. providing a fiber optic based distributed acoustic sensing measurement system through the production region;
b. gathering the acoustic measurements from the distributed acoustic sensing system as a function of the depth in the subsurface well and as a function of the elapsed time;
c. displaying the acoustic data for analysis of analysis of initiation points near wellbores created by hydraulic fracturing;
d. using the distributed acoustic data in conjunction with the depth derivative data to further refine and validate fracture initiation points.

7. A method for using the depth derivative of distributed temperature sensing data to identify initiation points near wellbores created by hydraulic fracturing comprising:
a. providing a fiber optic based distributed temperature sensing measurement system through the hydraulic fracturing or other fluid injection region;
b. gathering the temperatures through the hydraulic fracturing or other fluid injection region as a function of the depth in the subsurface well and as a function of the elapsed time;
c. calculating from the gathered data the depth derivative of the temperature changes as a function of depth through the hydraulic fracturing region and of the elapsed time;
d. assembling the data into a DTS matrix of [m x n] wherein m is the number of sample collected in the depth scale and n is the number of samples collected in the time scale;
e. for each column of the DTS matrix calculating a derivative of the temperature as a function of depth and storing it in a new matrix with dimensions [m−2×n];
f. displaying the derivative matrix with one axis as time and another axis as depth and color coding the value of the temperature derivative;
g. adjusting the color scheme until one or more persistent horizontal stripes is found throughout the elapsed time period with distinct color from adjacent zones;
h. displaying the depth derivative data for analysis of the fluid levels by operators to identify the depth boundaries in which fractures have been created.

8. The method for using the depth derivative of distributed temperature sensing data to identify initiation points near wellbores created by hydraulic fracturing or other fluid injection of claim 7 wherein the depth derivative data is displayed in colors as a function of depth and time on a display monitor.

9. The method for using the depth derivative of distributed temperature sensing data to identify initiation points near wellbores created by hydraulic fracturing or other fluid injection of claim 7 wherein the depth derivative data is displayed in black/white as a function of depth and time on a display monitor.

10. The method for using the depth derivative of distributed temperature sensing data to identify initiation points near wellbores created by hydraulic fracturing or other fluid injection of claim 7 wherein the numerical values of the depth derivative data are recorded and printed or displayed.

11. The method for using the depth derivative of distributed temperature sensing data to identify initiation points near wellbores created by hydraulic fracturing or other fluid injection of claim 7 wherein the depth derivative data is displayed in grey scale as a function of depth and time on a display monitor.

12. The method for using the depth derivative of distributed temperature sensing data to monitor identify initiation points near wellbores created by hydraulic fracturing or other fluid injection further comprising:
a. providing a fiber optic based distributed acoustic sensing measurement system through the production region;
b. gathering the acoustic measurements from the distributed acoustic sensing system as a function of the depth in the subsurface well and as a function of the elapsed time;
c. displaying the acoustic data for analysis of analysis of initiation points near wellbores created by hydraulic fracturing or other fluid injection;
d. using the distributed acoustic data in conjunction with the depth derivative data to further refine and validate fluid and fracture initiation points.
